(19) United States
(12) Patent Application Publication
(10) Pub. No.: US 2016/0255991 A1
(43) Pub. Date: Sep. 8, 2016

(54) Automatic Mixed Drink Dispenser With Single Serving Ingredient Cartridge

(71) Applicant: Monsieur, Inc., Dover, DE (US)

(72) Inventors: Barry Maurice Givens, JR., Atlanta, GA (US); Paul Qantas Judge, Atlanta, GA (US); Donald Oneal Beamer, JR., Atlanta, GA (US); Mario Lyndell Taylor, II, Atlanta, GA (US)

(73) Assignee: Monsieur, Inc., Dover, DE (US)

(21) Appl. No.: 15/060,936

(22) Filed: Mar. 4, 2016

Related U.S. Application Data
(60) Provisional application No. 62/128,765, filed on Mar. 5, 2015.

(51) Int. Cl. A47J 31/40; B01F 3/04; A47J 31/41

(52) U.S. Cl. CPC A47J 31/407; A47J 31/41; B01F 3/04808; B01F 2003/049

(57) ABSTRACT

A device for dispensing a beverage includes a plurality of replaceable reservoirs, each respectively configured to contain a respective liquid ingredient. A plurality of pumps are each operatively connected to a respective reservoir and configured to transfer the respective liquid ingredient from one or more of the reservoirs. A plurality of nozzles are operatively connected to the plurality of pumps and configured to receive a liquid ingredient from at least one of the plurality of pumps. A single use beverage cartridge includes a second liquid ingredient and is configured to receive the liquid ingredient dispensed from the at least one of the plurality of pumps to generate a mix of the liquid ingredient with the second ingredient.

### TECHNICAL FIELD

This disclosure relates generally to beverage dispensing systems, and more particularly to a system, method, and apparatus for automatic beverage dispensing using a single serving ingredient cartridge.

### BACKGROUND

Creating custom cocktails (mixed drinks) may be time consuming, messy, and inconsistent, depending on the skill of the individual preparing the beverage. Sometime individuals may not know how to prepare a mixed beverage, but desire to enjoy custom prepared cocktails in their homes, offices, or other locations. Others may desire to have custom prepared cocktails automatically prepared using a convenient interface.

Event hosts, home users, and many others may benefit from systems, methods and apparatuses configured to automatically prepare and dispense a variety of mixed beverages, in a convenient format, without human error and minimum human interaction. Further, people may benefit from convenient single-use cartridges that may be automatically combined with a variety of liqueurs and other liquid ingredients to prepare high quality mixed beverages quickly and conveniently.

### SUMMARY

In one embodiment, a device for dispensing a beverage is disclosed. It may include a plurality of replaceable reservoirs each respectively configured to contain a respective liquid ingredient; a plurality of pump mechanisms, wherein each pump in the plurality of pump mechanisms is operatively connected to a respective reservoir from the plurality of replaceable reservoirs, and configured to transfer the respective liquid ingredient from one or more of the reservoirs; and a carbonation system operatively connected to one of the plurality of pump mechanisms, and configured to receive water from a water reservoir, carbonate the water, and transfer the carbonated water to the pump mechanism. It may further include a plurality of nozzles operatively connected to the plurality of pump mechanisms, configured to receive a liquid ingredient from at least one pump mechanism from the plurality of pump mechanism, dispense the liquid ingredient into a single use beverage cartridge comprising a second liquid ingredient, thereby mixing the liquid ingredient with the second ingredient, and dispense the mixed first and second liquid ingredients into a beverage receptacle. It may further include an age gateway module and a beverage dispensing device controller comprising a processor; and a non-transitory computer-readable storage medium disposed in communication with the processor and storing processor-executable instructions configured to, when executed, cause the processor to: receive, via an input device, instructions to prepare a beverage; verify, via the age gateway module, an age of a user; and responsive to determining that the age criterion is satisfied, prepare a beverage using the single serving beverage.

Before embodiments of the present systems and methods are described, it is to be understood that this disclosure is not limited to the particular platforms, systems, and methods described, as there can be multiple possible embodiments of the present disclosure which are not expressly illustrated in the present disclosures. It is also to be understood that the terminology used in the description is for the purpose of describing the particular versions or embodiments only, and is not intended to limit the scope of the present disclosure. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIGS. 1A and 1B illustrate an exemplary beverage dispenser according to some embodiments.

FIG. 2 is a functional block diagram of an exemplary beverage dispenser system according to some embodiments.

FIG. 3 illustrates an exemplary inline beverage chiller according to some embodiments.

FIG. 4 illustrates an exemplary cartridge receptacle according to some embodiments.

FIG. 5 is an exemplary beverage dispenser according to some embodiments.

FIG. 6 is a flow diagram illustrating a method for preparing a beverage in accordance with some embodiments.

FIG. 7 illustrates an exemplary user interface in accordance with some embodiments.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

Illustrative embodiments of the present disclosure are listed below.

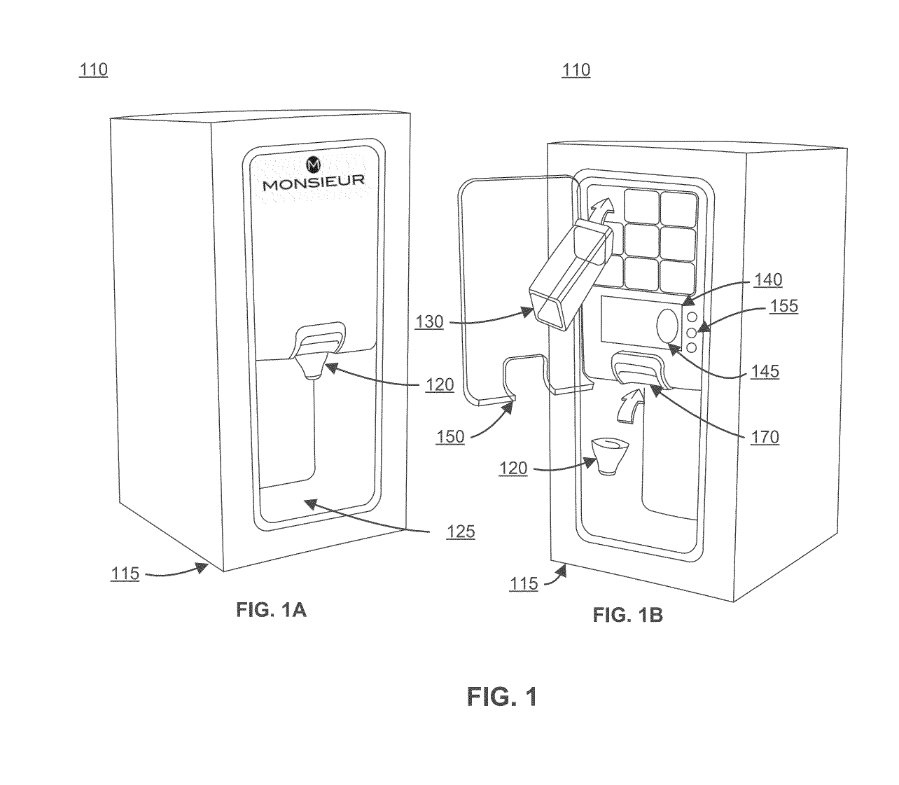

FIG. 1A depicts a beverage dispenser 110, which may include a housing 115. Housing 115 may include an access door 150 providing access to dispenser controls such as an input/output device 140, fingerprint scanner 145, and beverage control buttons 150. Access door 150 may also provide access to beverage ingredients. For example, dispenser 110 may be configured to receive are removable and replaceable single-serving ingredient cartridge 120 (hereafter “cartridge 120”). Cartridge 120 may be configured to fit in cartridge receptacle 170. Dispenser 110 may also be configured to receive one or more ingredient reservoir(s) 130. Dispenser 110 may transfer liquid ingredients from reservoir 130, and dispense the liquid ingredients via cartridge 120, which may contain one or more beverage flavorings, liqueurs, mixers, etc. By dispensing through cartridge 120, the liquid ingredients transferred from reservoir 130 is injected into cartridge 120, mixed with the contents therein, and dispensed for consumption.

Dispenser 110 may dispense the liquid ingredients into a receptacle such as a cup, glass, etc. (not shown) situated to fit in a recess 125. Dispenser 110 may include a backsplash and a drain pan assembly (not shown), which may be configured to fit within recess 125. Spillage and drips from cartridge 120 may fall through the spaces of a grill (not shown) into a drain pan assembly (not shown) for disposal.

As shown in FIG. 1B, access door 150 may be opened to access ingredient reservoirs 130, a user interface (e.g., input/output device 140) for controlling dispenser 110, dispenser control buttons 155, fingerprint reader 145, and cartridge receptacle 170. Dispenser 110 may be portable in nature and may generally be placed on a table or countertop. Dispenser 110 may be fabricated from one or more materials, including polycarbonates, ceramics, metals, plastics, etc. For convenience, subsequent portions of this description will refer to any combination of those ingredients or any single consumable ingredient collectively as a “drink” or a “beverage.”

Dispenser 110 may be configured to hold a plurality of liquid ingredients in one or more reservoir(s) 130. Reservoir 130 may contain one or more pre-filled liquid ingredients, such as, for example, spirits, wine, soft drinks and/or drink syrups, etc. For example, reservoir 130 may contain a liqueur (e.g., vodka). Dispenser 110 may hold a plurality of reservoirs 130, each containing a liquid ingredient. Reservoir 130 may be configured to be a single unit ingredient cartridge containing enough liquid ingredients for multiple mixed beverages. For example, according to some embodiments, reservoir 130 may contain 375 mL of a liquid ingredient such as vodka, rum, etc. According to other embodiments, reservoir 130 may contain a larger quantity of liquid ingredient, such as, for example, 500 mL of brandy. Although reservoir 130 may be replaced with a full reservoir once the liquid ingredient is depleted, reservoir 130 may be disposable and non-refillable.

Reservoir 130 may include one or more means for communicating information including beverage type, volume, date information, expiration information, liquid level, and/or other information to beverage dispenser 110. For example, reservoir 130 may include an RFID chip configured to communicate information to dispenser 110 when operatively installed in the dispenser. According to other embodiments, reservoir 130 may be configured to include a near field communication (NFC) module, and/or other module capable of communicating unique information to dispenser 110 in connection with reservoir 130.

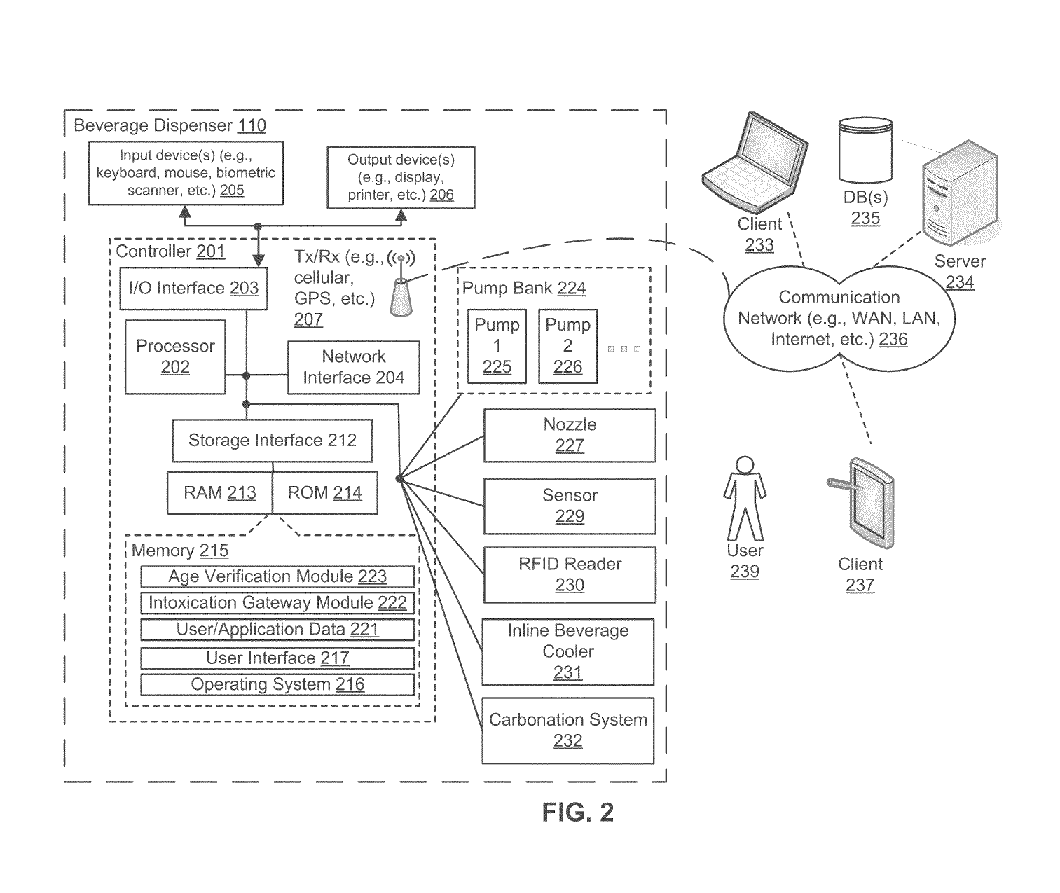

According to some embodiments, reservoir 130 and/or dispenser 110 may determine a liquid level of a liquid ingredient inside of reservoir 130. For example, a proximity indicator (not shown) may be configured to determine an approximate level of liquid ingredient remaining in reservoir 130. The proximity indicator may include a disposable sensor (e.g., sensor 220 as shown in FIG. 2) configured as part of reservoir 130, or be operatively connected to dispenser 130 and remain with the dispenser after reservoir 130 is replaced, and the empty reservoir is discarded. According to some embodiments, reservoir 130 may be configured to operate with dispenser 110, and only with dispenser 110. For example, reservoir 130 may be configured to be unusable as a stand-alone bottle.

Dispenser 110 may also include one or more sensors (e.g., sensor 229 depicted in FIG. 2) configured to detect the presence and approximate size of a beverage receptacle (e.g., a cup) placed in recess 125. The sensor(s) described herein may be one sensor or a plurality of sensors. Accordingly, the sensor(s) may include a sensor configured to detect the presence of a beverage receptacle, detect the presence of a bottle or liquid ingredient, detect the presence of one or more reservoir(s) 130, detect the presence of cartridge 120, etc. According to one aspect, the sensor(s) may detect the presence of a beverage receptacle, detect one or more dimensions of the receptacle, and transmit the information to a processor (not shown in FIG. 1). Accordingly, the processor may approximate a volume of the receptacle placed in the recess 125, and a beverage may be prepared by dispenser 110 using the volume information to proportion the respective liquid ingredients.

Input/output device 140 may include a main display area configured as a touch screen, and/or include one or more user-actuatable buttons that may be actuated to initiate various operations of dispenser 110. For example, input/output device 140 may include a button that may be actuated by a user to select a beverage or to begin flow of one or more liquid ingredients from nozzle 25. As another example, input/output device 140 might include a touch screen interface configured to display virtual buttons that are user-actuatable for performing administrative tasks, such as, for example, initial set up, ingredient selection, cartridge 120 selection, etc.

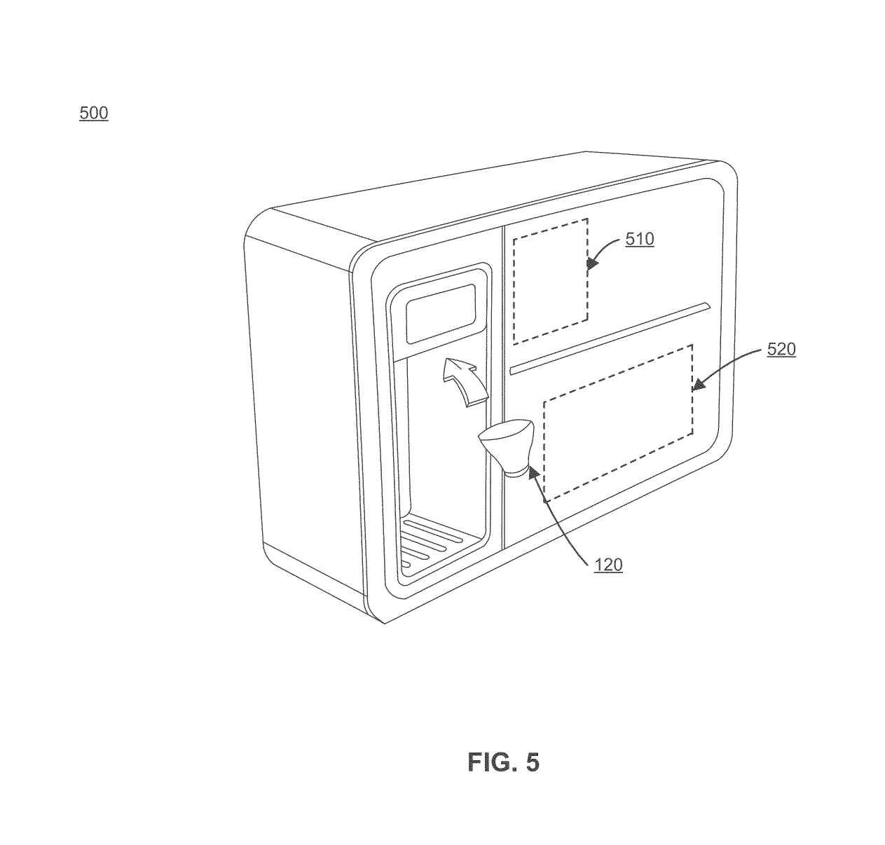

Generally, dispenser 110 includes a pump bank (224 as shown in FIG. 2) which may include a plurality of individual pump mechanisms. Any one or more pump mechanism in pump bank 224 may be operatively connected with a respective one or more reservoir(s) 130 and/or water reservoir 520 (as depicted in FIG. 5), and configured to receive one or more liquid ingredients from reservoir(s) 130 and water reservoir 520. Each pump mechanism in pump bank 224 may include a variable speed pump mechanism. For example, pump bank 224 may include one or more peristaltic pumps, or other type of pump configured to transfer liquid ingredients at a controllable rate.

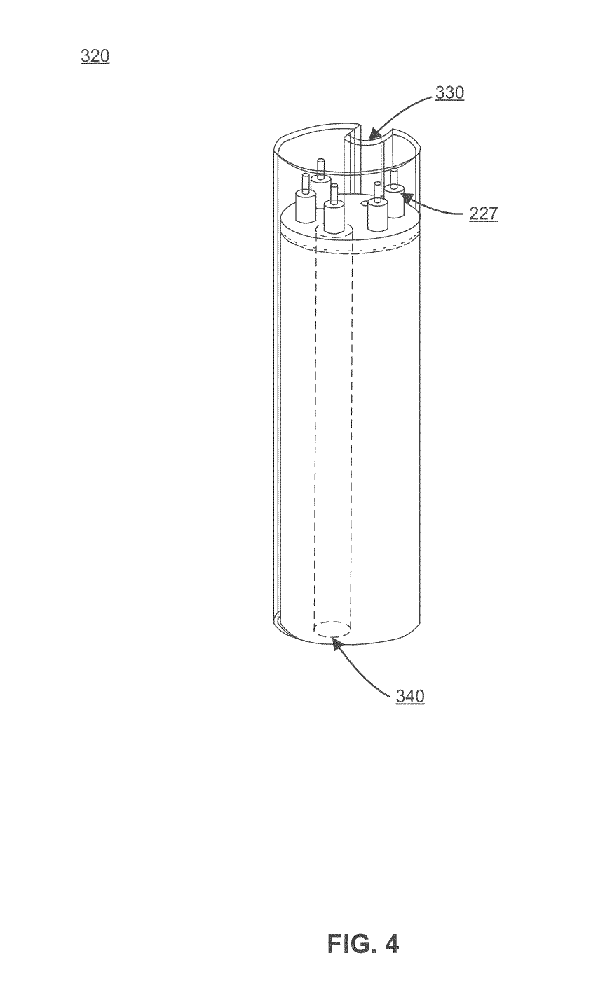

A controller, discussed in more detail with respect to FIG. 2, may be configured to store flow velocity data indicating the velocity each pump mechanism in pump bank 224 should pump when dispensing a selected liquid ingredient. In response to a signal from the input device 205, and based on its stored data, the controller may send an instruction to a pump to dispense an ingredient from reservoir(s) 130. For example, input/output device 140 may receive an instruction to prepare a beverage requiring the dispensing of two ingredients from reservoir(s) 130. If the selected beverage is comprised of two liquid ingredients, one ingredient may be required in a different proportion than the other ingredient. For example, ingredients A and B are liquid ingredients from respective reservoirs 130, where one reservoir contains ingredient A and another reservoir contains ingredient B. If the selected beverage has ingredient A at a ratio of 2:1 with respect to ingredient B, dispenser 110 may be configured to dispense two ounces of ingredient A and one ounce of ingredient B. The selected beverage may also include other ingredients included in single use cartridge 120, which may be dispensed in a particular order, at a particular speed, and/or in a particular quantity. Cartridge 120 is discussed in further detail with respect to FIG. 4 below.

According to one aspect, the liquid ingredients may be dispensed simultaneously. According to yet another aspect, the liquid ingredients may be dispensed sequentially, according to a beverage recipe. Pump bank 224 may also include pumps configured to incrementally dispense ingredients in measured amounts based on the dispensed volume rather than at a particular flow rate, as described above, without departing from the scope of the present disclosure.

FIG. 2 depicts an exemplary beverage dispenser system according to embodiments of the present disclosure. Variations of controller 201 may be used for implementing client 233, server 234, databases 235, and client 237. Controller 201 may comprise a central processing unit (“CPU” or “processor”) 202. Processor 202 may comprise at least one data processor for executing program components for executing user- or system-generated requests. A user 239 may include a person, a person using a device such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 202 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 202 may be disposed in communication with one or more input/output (I/O) devices via I/O interface 203. The I/O interface 203 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.11 a/b/g/n/x, Bluetooth, cellular (e.g., code-division multiple access (CDMA), high-speed packet access (HSPA+), global system for mobile communications (GSM), long-term evolution (LTE), WiMax, or the like), etc. Controller 201 may include a voice recognition system configured to listen for the presence of verbal commands (voice recognition). Accordingly, a user's previously recognized voice may be used an input may be provided to processor 202 for carrying out specific actions, such as ordering a beverage.

Using the I/O interface 203, the controller 201 may communicate with one or more I/O devices. For example, the input device 205 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 206 may be a printer, fax machine, video display (e.g., cathode ray tube (CRT), liquid crystal display (LCD), light-emitting diode (LED), plasma, or the like), audio speaker, etc. In some embodiments, a network interface 207 may be disposed in connection with the processor 202. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 202 may be disposed in communication with a communication network 236 via a network interface 204. The network interface 204 may communicate with the communication network 236. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 236 may include, without limitation, a direct interconnection, local area network (LAN), wide area network (WAN), wireless network (e.g., using Wireless Application Protocol), WiFi, Zigbee, the Internet, z-wave etc. Using the network interface 207 and the communication network 236, the controller 201 may communicate with devices 233, 234, and 237. These devices may include, without limitation, personal computer(s), server(s), printers, scanners, various mobile devices such as cellular telephones, smartphones (e.g., Apple iPhone, BlackBerry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the controller 201 may itself embody one or more of these devices. According to some embodiments, client beverage dispenser 238 may be in direct communication (via wired or wireless communication) with one or more client devices, e.g., client 237.

In some embodiments, the processor 202 may be disposed in communication with one or more memory devices (e.g., RAM 213, ROM 214, etc.) via a storage interface 212. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small controllers interface (SCSI), etc. The memory drives may further include a drum, magnetic disc drive, magneto-optical drive, optical drive, redundant array of independent discs (RAID), solid-state memory devices, solid-state drives, etc. Variations of memory devices may be used for implementing, for example, database 235.

The memory devices may store a collection of program or database components, including, without limitation, an operating system 216, user interface application 217, web browser 218, mail server 219, mail client 220, user/application data 221 (e.g., any data variables or data records discussed in this disclosure), age verification module 223, a voice recognition engine, etc. The operating system 216 may facilitate resource management and operation of the controller 201. Examples of operating systems may include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, and/or the like. Input device 205 and output device 206 may facilitate display, execution, interaction, manipulation, or operation of program components through textual or graphical facilities. For example, user interfaces may provide computer interaction interface elements on a display system operatively connected to the controller 201, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like. According to some embodiments, input device 205 and output device 206 may be a unified device, such as, for example, a touch screen and/or the like.

In some embodiments, the controller 201 may implement a web browser stored program component (not shown). The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc.

In some embodiments, controller 201 may store user/application data 221, such as the data, variables, records, etc. (e.g., beverage data, a beverage suggestion data, user profile data, data in connection with reservoir 130, data in connection with cartridge 120, etc.) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various controllers discussed above in this disclosure. It is to be understood that the structure and operation of any computer or database component may be combined, consolidated, or distributed in any working combination.

Furthermore, one or more non-transient computer-readable storage media may be utilized in implementing embodiments consistent with the present disclosure. A non-transitory computer-readable storage medium refers to any type of physical memory on which information or data readable by a processor may be stored. Thus, a non-transitory computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

Controller 201 may be configured to power and/or control nozzle 227, sensor 229, RFID reader 230, inline beverage chiller 231, and/or carbonation system 232. Controller 201 may also be configured to power and control pumps 225 and 226 of pump bank 224. Each pump in the plurality of pump mechanisms is operatively connected to a respective reservoir 130, and configured to transfer a liquid ingredient from the respective reservoir 130 to nozzle 25. In response to control signals and/or power from controller 201, each pumping mechanism may transfer a liquid ingredient from a respective reservoir 130 to nozzle 25 via one or more operatively connected tubes (not shown). Beverage dispenser 110 may also include one or more temperature control mechanisms (such as, for example, inline beverage cooler 231) configured to cool beverages while dispensing and/or maintain a predetermined temperature in one or more reservoirs 130.

Each reservoir 130 may be operatively connected to one or more sensors 229. Sensor 229 may be a proximity indicator, e.g., a liquid level sensor, or solid material sensor, RFID (radio frequency ID) readers, bar code scanners, OCR (optical character recognition) scanners, etc. Sensor 229 may periodically transmit data to processor 202 indicating the measured ingredient level in each reservoir(s) 130. If the ingredient level is below a certain threshold, processor 202 may provide instructions to output device 206 to display an appropriate message indicating a low ingredient level. Processor 202 may also initiate instructions to transmit a text message (SMS message and/or the like) to a predetermined user of the dispenser 110, where the message includes an indication of the ingredient levels.

User application data 221 may include a beverage suggestion engine. The beverage suggestion engine may be configured to provide a user with a listing of beverages suggested based on a previously stored, and/or newly created profile data. More particularly, the beverage suggestion engine may be configured to utilize stored profile data to provide a listing of beverages to user 239 based on available ingredients stored in reservoir(s) 130. The beverage suggestion engine may suggest beverages with similar characteristics to beverages previously ordered by a particular user, for example, user 239. Controller 201 may determine which drinks should be suggested based, at least in part, on available ingredient information determined by sensor 229 and/or input received via I/O interface 203. Memory 215 may be configured to store beverage history as part of user profile information.

User profile information may include information uniquely identifying a user of beverage dispenser 110. User profile information may include, but is not limited to, a user name, a photograph, a biometric identification, geographic data including addresses, GPS data, credit card information, bank account information, payment account information, other payment information, digital coupons, a password, a pass code, driver license information, other identification card information, beverage order history, multimedia delivery information, and/or user preferences, such as, for example, beverage preferences. According to some embodiments, user profile information may be stored on server 234, database 235, or another client 233. User profile information may also be stored in a remotely located client beverage dispenser 238. Accordingly, beverage dispenser 110 may communicate with client beverage dispenser 238, which may be operatively connected to dispenser 110 via communication network 236.

According to some embodiments, controller 201 may access a user profile. User profile information may be stored in memory 215, server 234, database 235, or in another operatively connected device. User profile information may also be stored on a computer-readable memory, such as, for example, a flash drive, a smart card, and/or an RFID memory, etc. According to some embodiments, processor 202 may communicate with server 234 to retrieve beverage suggestions from the data stored in server 234 based on the same or similar ingredients or characteristics. For example, processor 202 may access user profile information and determine that, on four previous occasions, the user has ordered beverages containing brandy. Processor 202 may determine that brandy is a liquid ingredient currently in reservoir(s) 22. Processor 202 may retrieve beverage recipes from server 234 and/or memory 215 that are brandy based, and present a listing of brandy based beverages for which beverage dispenser 110 is configured to prepare.

According to some embodiments, the beverage suggestion engine may suggest beverages based on other characteristics that have been previously tagged by the user or previously stored by a system administrator. The characteristics may include characteristic preferences based on a taste preference received by processor 202 from a user. For example, a taste preference may include flavor characteristics such as, for example, beverage strength (higher or lower proportions of a liquor ingredient), sweet (higher proportion of a sweet ingredient), sour (higher proportion of a sour ingredient), etc.

According to some embodiments, dispenser 110 may store user profile information on memory 215. Dispenser 110 may be configured to display a list of beverages according to unique beverage preference information stored as part of the user profile information. Processor 202 may direct output device 206 to present the list as a user-selectable list containing beverages with a predetermined taste characteristic preference for which beverage dispenser 110 is configured to prepare. Suggested beverages may be based on data corresponding to liquid ingredients contained in reservoir(s) 130, which may be stored in memory 215. Dispenser 110 may interact with one or more operatively connected computer-readable memories to retrieve and display a list of beverages based on this selection and data (hereafter “suggested beverages”).

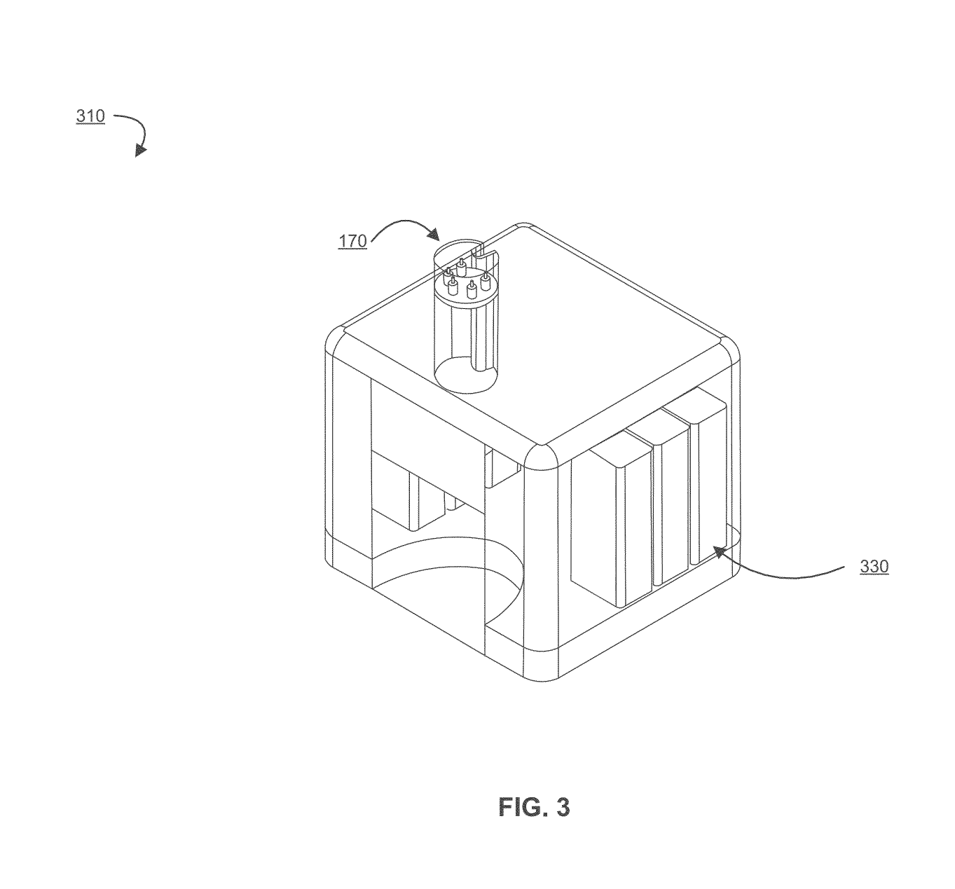

According to some embodiments, dispenser 110 may include an inline beverage cooler 231 that may be configured to cool dispensed liquid ingredients on demand, as they are dispensed. One advantage for providing inline beverage cooling is energy efficiency, which may be optimized by avoiding unnecessary energy usage when cooling beverages at times that dispenser 110 is not in use. FIG. 3 depicts an exemplary inline beverage chiller 231.

Referring now to FIG. 3, inline beverage chiller 231 is depicted according to some embodiments. Inline beverage chiller 231 may include a plurality of electrostatic cooling mechanisms 330 configured to cool liquid ingredients as they are dispensed. Inline beverage chiller 231 may include and/or be operatively connected to cartridge receptacle 320.

FIG. 4 depicts an exemplary cartridge receptacle 320, according to embodiments of the present disclosure. According to some embodiments, cartridge receptacle 320 includes a plurality of nozzles 227, which are configured to receive one or more liquid ingredients from reservoirs 130, and dispense the liquid ingredients to cartridge 120. For example, each of the plurality of nozzles 227 may receive a liquid ingredient via a channel (e.g., channel 340), and inject the liquid ingredient into cartridge 120. As the liquid ingredient is injected into a corresponding channel in cartridge 120, the liquid ingredient is mixed with the liquid ingredient(s) contained in the corresponding chamber of cartridge 120. For example, as seen in FIG. 4, cartridge receptacle 320 may be configured with five nozzles 227, each of which connected to a different liquid ingredient contained in a respective one of reservoirs 130. When dispenser 110 determines that a particular cartridge 120 is loaded into dispenser 110, dispenser 110 may actuate each of the corresponding pumps connected to nozzles 227 to dispense the necessary liqueurs to be mixed with the respective ingredients of cartridge 120. Each respective liquid ingredient from reservoir 130 is injected into the corresponding chamber of the cartridge 120, mixed with the respective cartridge ingredients, and dispensed into the receptacle via a pour spout (not shown) at the base of cartridge 120.

Each respective ingredient in cartridge 120 is kept in its own chamber, separate from the other ingredients. For example, the liquid ingredients contained in cartridge 120 can be dispensed in a particular order, at a particular speed, and in particular volumes. Cartridge receptacle 320 may include a key slot 330 or other means to determine a single orientation for cartridge 120. According to some embodiments, dispenser 110 can determine that a particular cartridge (e.g., sweet and sour, soft drink syrup, etc.) is loaded into cartridge receptacle 320 via a RFID tag included with cartridge 120. According to other embodiments, dispenser 110 requests user input regarding the cartridge such as a cartridge type, number, etc., receives the user input, and determines the proper nozzles and/or pumps to actuate according to the user input.

Referring now to FIG. 5, beverage dispenser 500 is depicted. According to some embodiments, beverage dispenser 500 may include a carbonation system 232, and a water reservoir 520. Carbonation system 232 may be configured to receive one or more CO2 cartridges (not shown), and carbonate water from water reservoir 520 on demand as needed. Accordingly, beverage dispenser 500 may be configured to prepare carbonated beverages, such as, for example, soft drinks using a cartridge 120 containing the appropriate soft drink syrup(s).

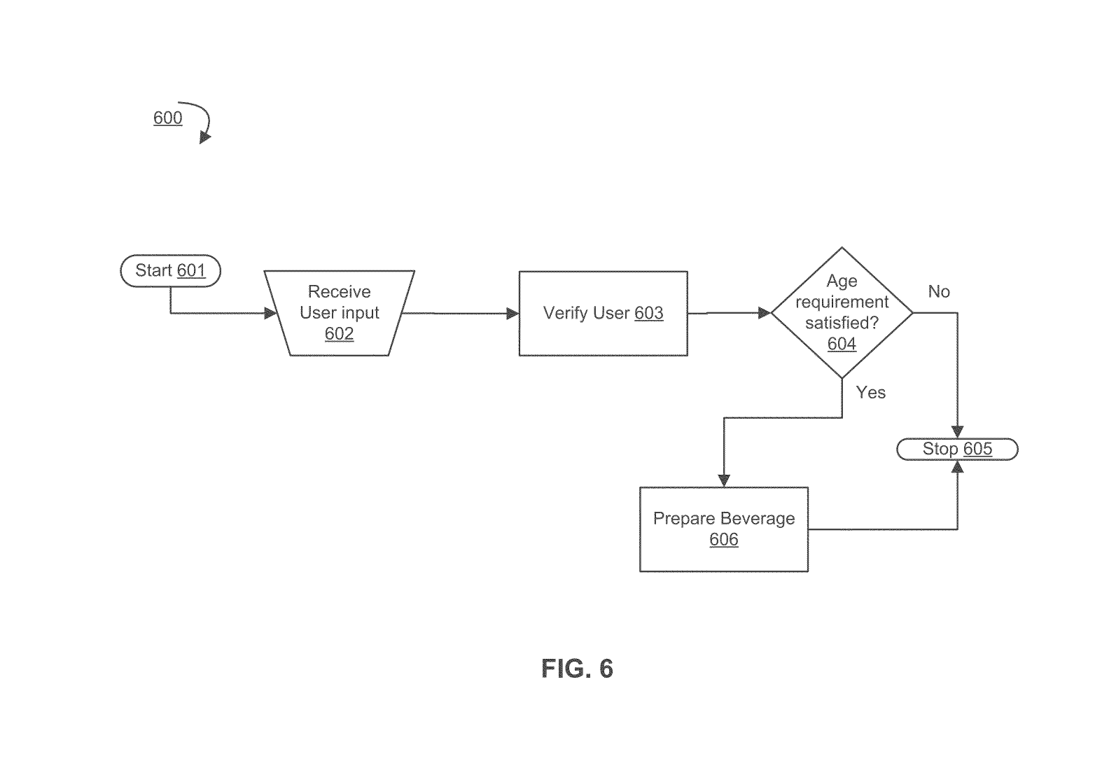

FIG. 6 illustrates a method for performing operations associated with setup of the dispenser. The operations presented below are intended to be illustrative. In some embodiments, the methods may be accomplished with one or more additional operations not described, and/or without one or more of the operations discussed. Additionally, the order in which the operations are illustrated in FIG. 6 and described below is not intended to be limiting.

According to some embodiments, the methods may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of the methods in response to instructions stored electronically on an electronic storage medium, such as memory 215 shown in FIG. 2. The one or more processing devices may include one or more devices configured through hardware, firmware, and/or software to be specifically designed for execution of one or more of the operations of the methods.

FIG. 6 illustrates a method of preparing a beverage using beverage dispenser 110. At operation 601, controller 201 may receive user input corresponding to a start command. Beverage dispenser 110 may prompt for and receive user input at step 602. User input may include information such as drink selection, cartridge type, cartridge number, reservoir 130 information, etc.

At step 603, if necessary, the processor may initiate age verification module 223. In some geographic regions, beverages containing substances that may influence behavior (for example, alcohol, herbal extracts, etc.) may be restricted to individuals at or above a pre-determined age. For example, in many jurisdictions, the age required for consumption of alcohol may be 21 years of age. Age verification module 223 may be configured to ensure that the user is of an age suitable to purchase one or more beverages from dispenser 110. If a beverage is ordered containing ingredients from one of the reservoirs previously indicated as having alcohol or another controlled substance, controller 201 may request that the user verify their age. Age verification may be performed by input device 205, such as, for example, a camera, a microphone, an RFID device, an identification card scanner, near-field communication (NFC) from a phone, and/or biometric readings of the user (e.g., a fingerprint) via fingerprint reader 145. Age verification module 223 may further include verification via face recognition, a pre-configured user login, password, identification code, etc. If the age of the user is not verified, controller 201 may prompt a display of a pre-programmed message indicating that the age verification was not complete, and thus, no beverage is dispensed. If the age verification module 223, in conjunction with controller 201, determines that the user's age is verified and suitable for the selected drink, controller 201 may prepare the beverage at step 606. At step 605 the process ends.

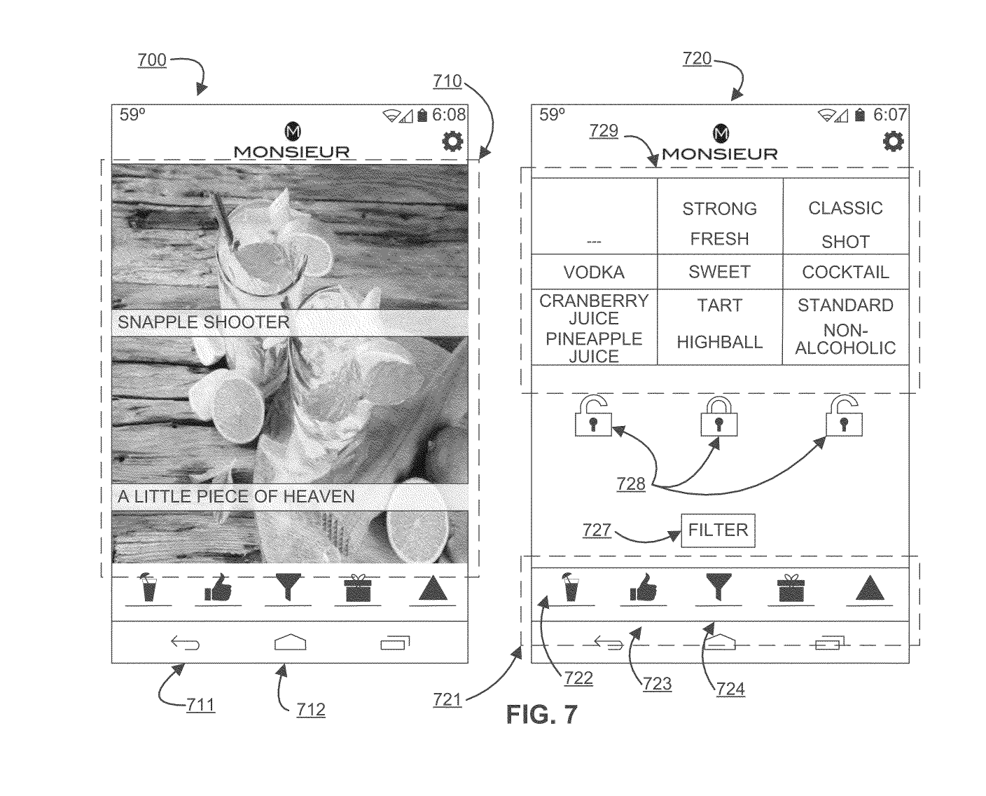

Dispenser 110 may be configured to work in conjunction with a mobile device to control the dispenser. For example, dispenser 110 may receive drink orders via a mobile application operating on a mobile device. Referring now to FIG. 7, an exemplary user interface for receiving user input via a mobile device is shown according to some embodiments. Beverage dispenser 110 may be configured to receive commands from an operatively connected mobile device, such as for example, client device 237. Client device 237 may communicate with the dispenser 110 via communication network 236 or via routing through server 234 to dispenser 110. The server 234 may be in communication with one or more databases 235, that store beverage selections and various items of data (application data) related to providing suggested beverages or beverage recipes to users of client device 237, as well as storing and using user profile data as described herein.

Referring now to FIG. 7, interface 700 may be included, as depicted in FIG. 7 as a home screen. Interface 700 may include navigation tools 711 and 721, and a multimedia viewing area 710. The interface may include, among other things, an email tool 712, which may provide a link to an email client. Interface 720 depicts a beverage selection screen that may be enabled via selectable icon 722. Other user-selectable icons may be included, such as a recommendations tool 723, a filter tool 724 (depicted as interface 720), etc.

Interface 720 may include a filter tool 724 for providing a drink recommendation in accordance with discloses embodiments. Accordingly, a plurality of user-selectable drink attribute tools 729 may be configured to receive user input corresponding to desired drink attributes. A processor of client 237 may receive the user input, store the data corresponding to the input to a memory, and determine one or more beverages for recommendation according to disclosed embodiments herein.

According to some embodiments, interface 720 may include user-selectable filter lock buttons 728, which may lock or unlock each respective drink attribute tools 729. For example, if the locks shown in 728 as “unlocked” are selected, they may toggle to “lock”, and vice-versa. An unlocked button allows the series of beverage attributes above to be user selectable by sliding, scrolling, selecting, etc. A locked attribute maintains the selected attribute while the unlocked attributes may be changed. As shown in interface 720 “SWEET” is locked, and will not change, whereas “VODKA” and “COCKTAIL” may be changed. A user selectable “Filter” tool 727 may be actuated to execute the beverage filter tool. Accordingly, client 737 may provide a beverage recommendation according to the selected attributes 729. Interface 730 depicts the results of the filtered recommendation shown as an example in interface 720.

It is intended that the disclosure and examples be considered as exemplary only, with a true scope and spirit of disclosed embodiments being indicated by the following claims.

What is claimed is:

1. A device for dispensing a beverage, comprising:
a plurality of replaceable reservoirs, each respectively configured to contain a respective liquid ingredient;
a plurality of pumps, wherein each pump is operatively connected to a respective reservoir from the plurality of replaceable reservoirs, and configured to transfer the respective liquid ingredient from one or more of the reservoirs;
a plurality of nozzles operatively connected to the plurality of pumps and configured to receive a liquid ingredient from at least one of the plurality of pumps; and
a single use beverage cartridge comprising a second liquid ingredient and configured to receive the liquid ingredient dispensed from the at least one of the plurality of pumps to generate a mix of the liquid ingredient with the second ingredient.

2. The device of claim 1, comprising a beverage receptacle configured to receive the mixed first and second liquid ingredients dispensed from the single use beverage cartridge.

3. The device of claim 1, comprising a carbonation system operatively connected to one of the plurality of pumps, and configured to receive water from a water reservoir, carbonate the water, and transfer the carbonated water to at least one of the plurality of nozzles.

4. The device of claim 1, comprising an age gateway module configured to receive user information and determine an identity and/or age of the user.

5. The device of claim 4, comprising a beverage dispensing device controller configured to receive, via an input device, instructions to prepare a beverage and to verify, via the age gateway module, the age of the user.

6. The device of claim 5, wherein the beverage dispensing controller is configured to determine that the age of the user satisfies an age criterion and to prepare a beverage using the single use beverage cartridge if the age of the user satisfies the age criterion.

7. A beverage dispensing method, comprising:
transferring respective liquid ingredients from one or more of a plurality of replaceable reservoirs, each configured to contain a respective liquid ingredient, to one or more pumps;
dispensing one or more of the liquid ingredients into a single serving beverage cartridge comprising a second liquid ingredient to mix the one or more liquid ingredients with the second ingredient; and
dispensing the mixed one or more and second liquid ingredients into a beverage receptacle.

8. The method of claim 7, comprising receiving, in a carbonation system operatively connected to one of the one or more pumps, water from a water reservoir.

9. The method of claim 8, comprising carbonating the water and transferring the carbonated water to a nozzle operatively coupled to at least one of the one or more pumps.

10. The method of claim 7, comprising receiving, via an age gateway module, user information.

11. The method of claim 10, comprising determining an identity and/or age of the user based on the user information.

12. The method of claim 11, comprising receiving, via an input device, instructions to prepare a beverage and to verify, via the age gateway module, the age of the user.

13. The method of claim 12, comprising determining that the age of the user satisfies an age criterion and preparing a beverage using the single serving beverage cartridge if the age of the user satisfies the age criterion.

14. A tangible, non-transitory computer-readable storage medium storing processor-executable instructions that, when executed, cause the processor to perform a method comprising:
transferring respective liquid ingredients from one or more of a plurality of replaceable reservoirs, each configured to contain a respective liquid ingredient, to one or more pumps;
dispensing one or more of the liquid ingredients into a single use beverage cartridge comprising a second liquid ingredient to generate a mix of the one or more liquid ingredients with the second ingredient; and
dispensing the mixed one or more liquid ingredients and second liquid ingredient into a beverage receptacle.

15. The tangible, non-transitory computer-readable storage medium of claim 14, wherein the method further comprises receiving, in a carbonation system operatively connected to one of the one or more pumps, water from a water reservoir.

16. The tangible, non-transitory computer-readable storage medium of claim 15, wherein the method further comprises carbonating the water and transferring the carbonated water to a nozzle operatively coupled to at least one of the one or more pumps.

17. The tangible, non-transitory computer-readable storage medium of claim 14, wherein the method further comprises receiving, via an age gateway module, user information.

18. The tangible, non-transitory computer-readable storage medium of claim 17, wherein the method further comprises determining an identity and/or age of the user based on the user information.

19. The tangible, non-transitory computer-readable storage medium of claim 18, wherein the method further comprises receiving, via an input device, instructions to prepare a beverage and to verify, via the age gateway module, the age of the user.

20. The tangible, non-transitory computer-readable storage medium of claim 19, wherein the method further comprises determining that the age of the user satisfies an age criterion and preparing a beverage using the single serving beverage cartridge if the age of the user satisfies the age criterion.
